(19) United States
(12) Patent Application Publication
(10) Pub. No.: US 2022/0413730 A1
(43) Pub. Date: Dec. 29, 2022

(54) INFORMATION PROCESSING DEVICE, INFORMATION PROCESSING METHOD, AND INFORMATION PROCESSING PROGRAM

(71) Applicant: FUJIFILM CORPORATION, Tokyo (JP)

(72) Inventors: Michitaka KONDO, Tokyo (JP); Yutaka OISHI, Tokyo (JP); Takashi MIYAMOTO, Tokyo (JP); Terue WATANABE, Tokyo (JP); Koji MATSUMURA, Tokyo (JP); Yuko UNO, Tokyo (JP)

(21) Appl. No.: 17/929,302

(22) Filed: Sep. 1, 2022

Related U.S. Application Data
(63) Continuation of application No. PCT/JP2021/007942, filed on Mar. 2, 2021.

(30) Foreign Application Priority Data
Mar. 6, 2020 (JP) 2020-039322

(51) Int. Cl. G06F 3/06

(52) U.S. Cl. CPC G06F 3/0644; G06F 3/0653; G06F 3/0682; G06F 3/0604

(57) ABSTRACT

An information processing device includes at least one processor. The processor performs, in a case where an address relative value between a first address value indicating an end position in a tape running direction of recorded data which is data recorded in a first partition of a magnetic tape having the first partition in which data is recorded and a second partition in which metadata corresponding to the data is recorded and a second address value indicating an end position in the tape running direction of latest metadata recorded in the second partition is within a predetermined range, control to record metadata corresponding to recorded data recorded after the latest metadata is recorded, in the second partition.

### CROSS-REFERENCE TO RELATED APPLICATIONS

This application is a continuation application of International Application No. PCT/JP2021/007942, filed Mar. 2, 2021, the disclosure of which is incorporated herein by reference in its entirety. Further, this application claims priority from Japanese Patent Application No. 2020-039322 filed on Mar. 6, 2020, the disclosure of which is incorporated herein by reference in its entirety.

### BACKGROUND

### 1. Technical Field

The disclosed technique relates to an information processing device, an information processing method, and an information processing program.

### 2. Description of the Related Art

The following techniques are known as techniques related to processing of recording data in each of a plurality of partitions formed on a magnetic tape. For example, JP2013-206518A discloses a magnetic tape device comprising: a partition creation unit that creates a first partition in which an original file is recorded and a second partition in which a copy file of the original file is recorded, in a magnetic tape; a determination unit that determines a recording position of the copy file such that an average access distance from a magnetic head portion is the shortest position in a case where the copy file is created in the second partition; and a copy file recording unit that records the copy file on the recording position of the second partition determined by the determination unit.

JP2015-41389A discloses a tape medium including an index partition (IP) that stores an index (metadata) of a file; and a data partition (DP) that stores data of the file, in which the IP includes a first area (IP1) and a second area (IP2).

### SUMMARY

Incidentally, as described in JP2013-206518A and JP2015-41389A, in a recent magnetic tape, partitions can be divided into, for example, a first partition in which data is recorded and a second partition in which metadata corresponding to the data is recorded. For example, one or more specific wraps of the magnetic tape are used as the second partition in which metadata is recorded, another one or more wraps are used as a guard band that separates the first partition and the second partition, and the remaining wraps are used as the first partition in which data is recorded. A recording head moves relative to the magnetic tape along a running direction of the magnetic tape (hereinafter, referred to as a tape running direction), whereby data and metadata are sequentially recorded along the tape running direction.

Here, a case where metadata corresponding to the data recorded in the first partition is recorded in the second partition, for example, in a case where the number or size of the recorded data reaches a predetermined value determined in advance will be considered. In this case, the recording position of the data recorded in the first partition on the magnetic tape and the recording position of the corresponding metadata recorded in the second partition on the magnetic tape may significantly deviate from each other. In this case, it takes a long time to move the recording head relative to the magnetic tape to the recording position of the metadata after recording the data in the first partition. It takes as long as 100 seconds to move the recording head relative to the magnetic tape from one end to the other end of the magnetic tape, for example, in a case where the running speed of the magnetic tape is 10 m/sec and the total length of the magnetic tape is 1 km.

The disclosed technique has been made in view of the above circumstances, and an object thereof is to provide an information processing device, an information processing method, and an information processing program capable of shortening the time required for recording data and metadata by shortening a movement distance of a recording head relative to a magnetic tape in a case where data and metadata are recorded on the magnetic tape.

According to the disclosed technique, there is provided an information processing device comprising: at least one processor, in which the processor performs, in a case where an address relative value between a first address value indicating an end position in a tape running direction of recorded data which is data recorded in a first partition of a magnetic tape having the first partition in which data is recorded and a second partition in which metadata corresponding to the data is recorded and a second address value indicating an end position in the tape running direction of latest metadata recorded in the second partition is within a predetermined range, control to record metadata corresponding to recorded data recorded after the latest metadata is recorded, in the second partition.

The processor may perform control to record the metadata corresponding to the recorded data recorded after the latest metadata is recorded, in the second partition, in a case where the address relative value is within the predetermined range and the number or a size of the recorded data recorded after the latest metadata is recorded is a predetermined value or more.

The processor may perform control to record the metadata corresponding to the recorded data recorded after the latest metadata is recorded, in the second partition, in a case where the address relative value is within the predetermined range and a predetermined time is passed from a point in time when the latest metadata is recorded.

The processor may change the predetermined range according to at least one of a size of the metadata corresponding to the recorded data recorded after the latest metadata is recorded, a running speed of the magnetic tape, or a recording direction in a case where the data and the metadata are recorded on the magnetic tape. Alternatively, a plurality of ranges of the address relative value may be set as the predetermined range.

The first partition and the second partition may be storage areas separated from each other in a width direction intersecting the tape running direction. Alternatively, the first partition and the second partition may be storage areas separated from each other in the tape running direction.

According to the disclosed technique, there is provided an information processing method executed by a processor provided in an information processing device, the method comprising: performing, in a case where an address relative value between a first address value indicating an end position in a tape running direction of recorded data which is data recorded in a first partition of a magnetic tape having the first partition in which data is recorded and a second partition in which metadata corresponding to the data is recorded and a second address value indicating an end position in the tape running direction of latest metadata recorded in the second partition is within a predetermined range, control to record metadata corresponding to recorded data recorded after the latest metadata is recorded, in the second partition.

According to the disclosed technique, there is provided an information processing program for causing a processor provided in an information processing device to execute a process comprising: performing, in a case where an address relative value between a first address value indicating an end position in a tape running direction of recorded data which is data recorded in a first partition of a magnetic tape having the first partition in which data is recorded and a second partition in which metadata corresponding to the data is recorded and a second address value indicating an end position in a tape running direction of latest metadata recorded in the second partition is within a predetermined range, control to record metadata corresponding to recorded data recorded after the latest metadata is recorded, in the second partition.

According to the disclosed technique, a movement distance of a recording head relative to a magnetic tape in a case where data and metadata are recorded on the magnetic tape is shortened, so that the time required for recording data and metadata can be shortened.

### BRIEF DESCRIPTION OF THE DRAWINGS

Exemplary embodiments according to the technique of the present disclosure will be described in detail based on the following figures, wherein:

FIG. 1 is a diagram showing an example of a configuration of a recording and reproducing system according to an embodiment of the disclosed technique;

FIG. 2 is a diagram showing a hardware configuration of an information processing device according to the embodiment of the disclosed technique;

FIG. 3 is a functional block diagram showing an example of a functional configuration of the information processing device according to the embodiment of the disclosed technique;

FIG. 4 is a diagram showing an example of a state in which data is stored in a data cache according to the embodiment of the disclosed technique and metadata is stored in a metadata DB;

FIG. 5 is a diagram showing a recording direction of a magnetic tape according to the embodiment of the disclosed technique;

FIG. 6 is a diagram showing an example of a method of recording data on the magnetic tape;

FIG. 7A is a diagram showing an example of recording data in a data partition of a magnetic tape in which a metadata group is recorded in a reference partition;

FIG. 7B is a diagram showing an example of recording data in the data partition of the magnetic tape in which the metadata group is recorded in the reference partition;

FIG. 8A is a diagram showing an example of metadata recording timing according to the embodiment of the disclosed technique;

FIG. 8B is a diagram showing an example of metadata recording timing according to the embodiment of the disclosed technique;

FIG. 9A is a diagram showing an example of metadata recording timing according to the embodiment of the disclosed technique;

FIG. 9B is a diagram showing an example of metadata recording timing according to the embodiment of the disclosed technique;

FIG. 10A is a diagram showing an example of metadata recording timing according to the embodiment of the disclosed technique;

FIG. 10B is a diagram showing an example of metadata recording timing according to the embodiment of the disclosed technique;

FIG. 11A is a diagram showing an example of metadata recording timing according to the embodiment of the disclosed technique;

FIG. 11B is a diagram showing an example of metadata recording timing according to the embodiment of the disclosed technique;

FIG. 12A is a diagram showing an example of metadata recording timing according to the embodiment of the disclosed technique;

FIG. 12B is a diagram showing an example of metadata recording timing according to the embodiment of the disclosed technique;

FIG. 13A is a diagram showing an example of metadata recording timing according to the embodiment of the disclosed technique;

FIG. 13B is a diagram showing an example of metadata recording timing according to the embodiment of the disclosed technique;

FIG. 14 is a flowchart showing a flow of recording processing according to the embodiment of the disclosed technique;

FIG. 15 is a flowchart showing a flow of recording processing according to the embodiment of the disclosed technique;

FIG. 16 is a flowchart showing a flow of recording processing according to the embodiment of the disclosed technique; and

FIG. 17 is a diagram showing an example of a configuration of a partition of the magnetic tape.

### DETAILED DESCRIPTION

Hereinafter, an example of an embodiment of the disclosed technique will be described with reference to the drawings. The same or equivalent constituent elements and parts are given the same reference numerals in each drawing, and overlapping description will not be repeated as appropriate.

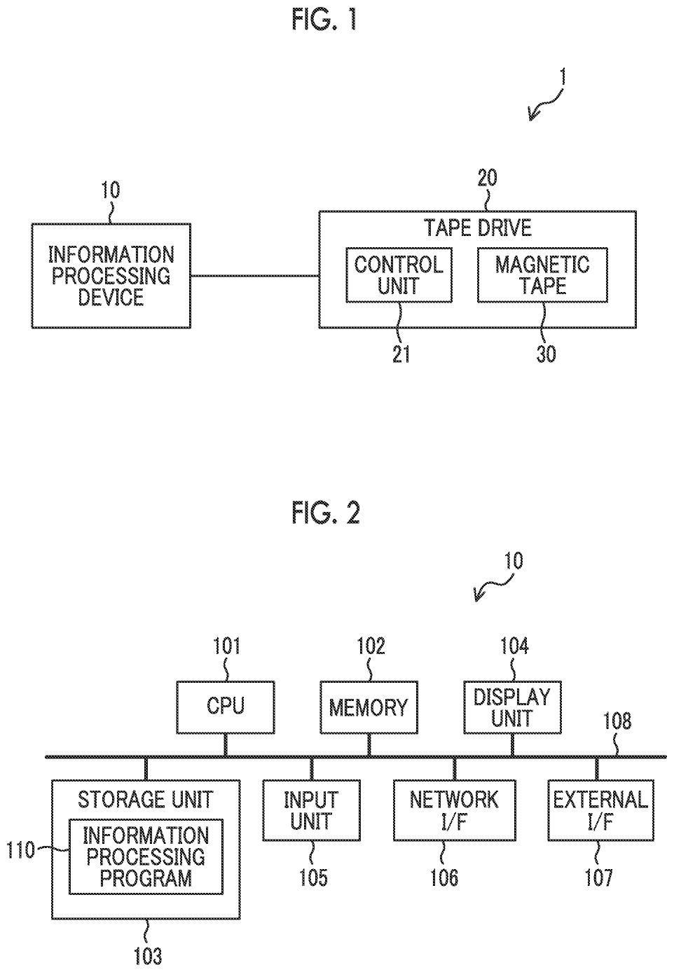

FIG. 1 is a diagram showing an example of a configuration of a recording and reproducing system 1 according to the embodiment of the disclosed technique. The recording and reproducing system 1 includes an information processing device 10 and a tape drive 20. Each tape drive 20 is connected to the information processing device 10. A magnetic tape 30 as an example of a recording medium is loaded into the tape drive 20. The tape drive 20 comprises a control unit 21 including a processor, such as a programmable logic device (PLD). The control unit 21 records (writes) data on the magnetic tape 30 loaded in the tape drive 20 and reads out data from the magnetic tape 30, on the basis of an instruction from the information processing device 10. An example of the magnetic tape 30 includes a linear tape-open (LTO) tape. The information processing device 10 performs control to record and read out data with respect to the magnetic tape 30.

FIG. 2 is a diagram showing a hardware configuration of the information processing device 10. The information processing device 10 includes a central processing unit (CPU) 101, a memory 102 serving as a temporary storage area, and a non-volatile storage unit 103. In addition, the information processing device 10 includes a display unit 104, such as a liquid crystal display, an input unit 105, such as a keyboard and a mouse, a network interface (I/F) 106 connected to a network, and an external I/F 107 to which the tape drive 20 is connected. The CPU 101, the memory 102, the storage unit 103, the display unit 104, the input unit 105, the network I/F 106, and the external I/F 107 are connected to a bus 108.

The storage unit 103 is realized by a storage medium such as a hard disk drive (HDD), a solid state drive (SSD), or a flash memory. The storage unit 103 stores an information processing program 110. The CPU 101 reads out the information processing program 110 from the storage unit 103 and then develops the information processing program 110 into the memory 102, and executes the information processing program 110. An example of the information processing device 10 includes a server computer. The CPU 101 is an example of the processor in the disclosed technique.

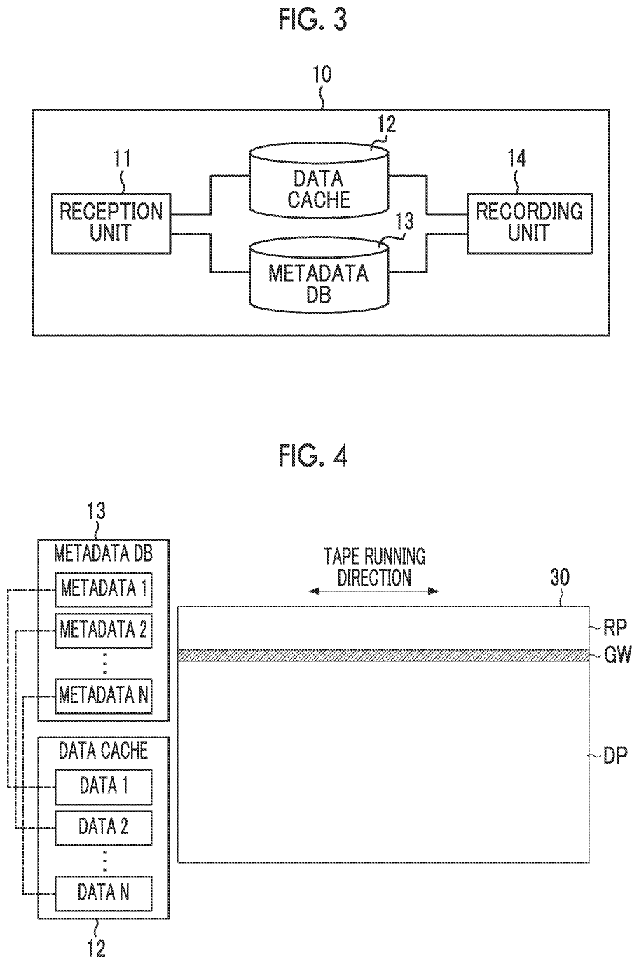

FIG. 3 is a functional block diagram showing an example of a functional configuration of the information processing device 10 in a case where data is recorded on the magnetic tape 30. As shown in FIG. 3, the information processing device 10 includes a reception unit 11 and a recording unit 14. The CPU 101 executes the information processing program 110, whereby the information processing device 10 functions as the reception unit 11 and the recording unit 14. Further, a data cache 12 and a metadata database (DB) 13 are stored in a predetermined storage area of the storage unit 103.

The reception unit 11 receives data supplied from the outside and metadata corresponding to the data, via the network I/F 106. The reception unit 11 stores the received data in the data cache 12 and stores the metadata in the metadata DB 13. The metadata includes identification information such as a data name of corresponding data, a data size, and attribute information indicating a data attribute such as a time stamp.

FIG. 4 shows an example of a state in which data is stored in the data cache 12 and metadata is stored in the metadata DB 13. Further, FIG. 4 shows a formatted magnetic tape 30 in which data and metadata have not been recorded. As shown in FIG. 4, data is stored in the data cache 12, and metadata is stored in the metadata DB 13 in association with the data.

Meanwhile, in the magnetic tape 30, a data partition DP in which data is recorded and a reference partition RP in which metadata corresponding to the data is recorded are formed through the format. In the present embodiment, the data partition DP and the reference partition RP are storage areas separated from each other in a width direction of the magnetic tape 30 intersecting a running direction. Guard wraps GW including a plurality of wraps are formed at a boundary portion between the data partition DP and the reference partition RP. The data partition DP is an example of the first partition in the disclosed technique, and the reference partition RP is an example of the second partition in the disclosed technique.

The recording unit 14 performs control to record the data stored in the data cache 12, in the data partition DP of the magnetic tape 30 loaded in the tape drive 20. At this time, the recording unit 14 adds the identification information of the magnetic tape 30 on which corresponding data is recorded, and management information for managing recorded data, such as information indicating a recording position on the magnetic tape 30, to metadata.

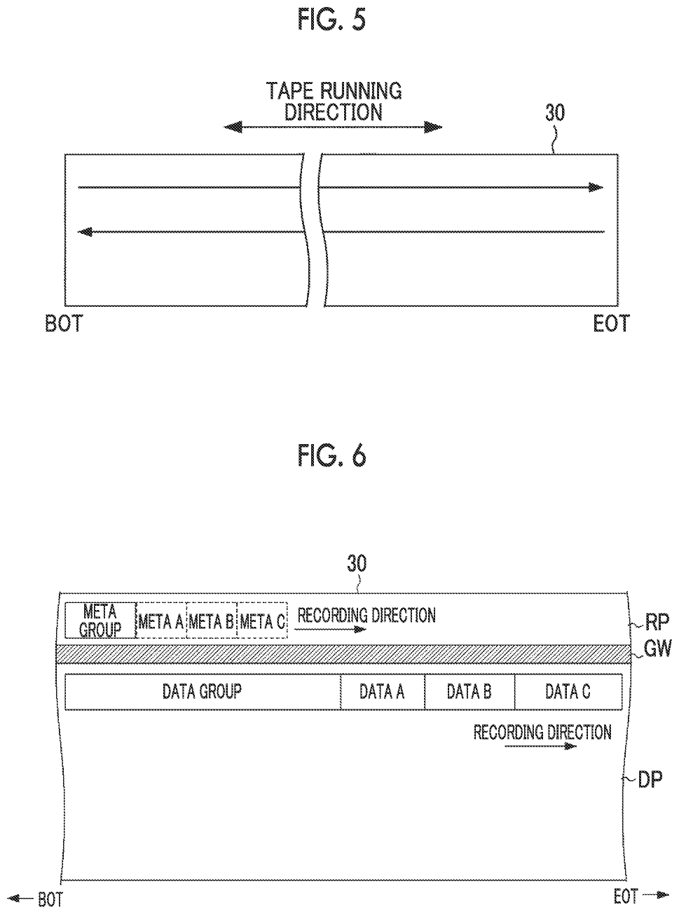

In the present embodiment, a linear recording method of recording data along the running direction of the magnetic tape 30 is employed as a method of recording data on the magnetic tape 30. As shown in FIG. 5, a recording head (not shown) provided in the tape drive 20 first records data from the beginning of tape (BOT) to the end of tape (EOT) of the magnetic tape 30 (that is, in a forward direction). In a case where the data recording position reaches the EOT, the recording head moves to another track in the same data band and records data from the EOT to the BOT of the magnetic tape 30 (that is, in a reverse direction).

Here, timing of recording metadata corresponding to the data recorded in the data partition DP, in the reference partition RP, will be considered. FIG. 6 is a diagram showing an example of a case where metadata corresponding to the recorded data is recorded in the reference partition RP each time the size of the data recorded in the data partition DP is a predetermined value or more.

The tape drive 20 records data in the data partition DP while moving the recording position of the recording head relative to the magnetic tape 30 in a direction from the BOT to the EOT of the magnetic tape 30. In a case where the size of a data group consisting of a plurality of data recorded in the data partition DP is a predetermined value or more, the tape drive 20 moves the recording position of the recording head to a recording start position of metadata of the reference partition RP, and records a metadata group corresponding to the recorded data group, in the reference partition RP. After that, the tape drive 20 moves the recording position of the recording head to an end position of the recorded data group of the data partition DP, and records data from that position to the EOT. In a case where the total size of data A, data B, and data C when data A, data B, and data C are recorded is the predetermined value or more, the tape drive 20 moves the recording position of the recording head to an end position of the recorded metadata group of the reference partition RP, and records metadata A, metadata B, and metadata C corresponding to the respective recorded data A, data B, and data C from that position to the EOT.

In this way, in a case where metadata corresponding to data recorded in the data partition DP is recorded in the reference partition RP, the tape drive 20 moves the recording position of the recording head to the end position of the latest metadata recorded in the reference partition RP from the end position of the data. As shown in FIG. 6, in a case where metadata corresponding to data recorded in the data partition DP is recorded in the reference partition RP each time the size of the recorded data is the predetermined value or more, the recording position of data recorded in the data partition DP on the magnetic tape 30 and the recording position of corresponding metadata recorded in the reference partition RP on the magnetic tape 30 may significantly deviate from each other. In this case, it takes a long time to move the recording head relative to the magnetic tape 30 to the recording start position of metadata after recording data in the data partition DP.

In that respect, as described below, the recording unit 14 of the information processing device 10 according to the present embodiment controls the timing of recording metadata in the reference partition RP so that the movement distance of the recording head relative to the magnetic tape is shortened and the time required for recording data and metadata is shortened.

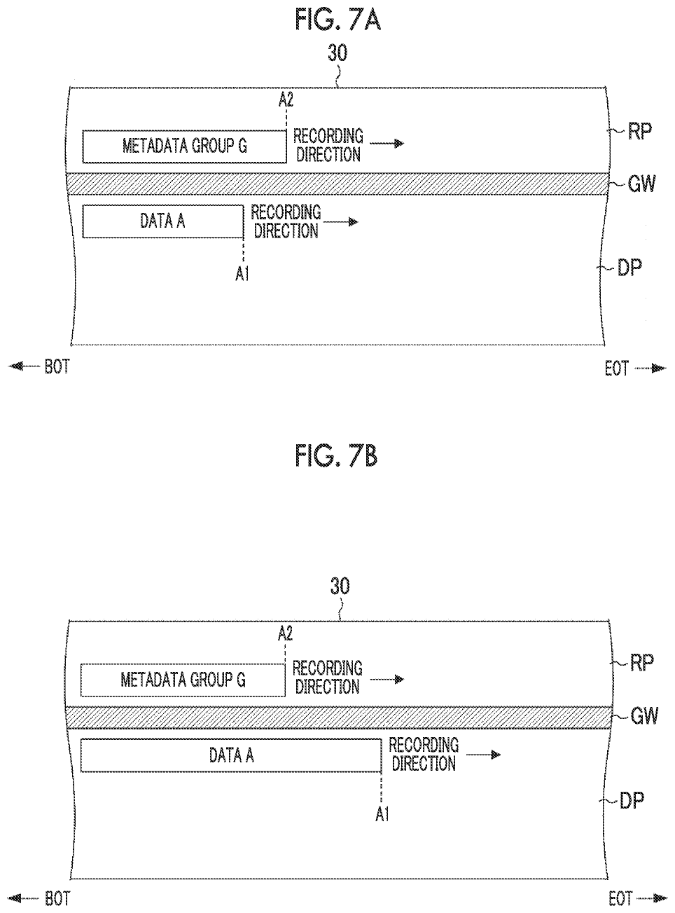

FIGS. 7A and 7B are each a diagram showing an example of recording data A in the data partition DP of the magnetic tape 30 in which a metadata group G is recorded in the reference partition RP. That is, the data A is data recorded after the metadata group G is recorded. In FIGS. 7A and 7B, a case where the recording directions of data and the metadata are each a direction (forward direction) from the BOT to the EOT of the magnetic tape 30 is illustrated. Further, in FIGS. 7A and 7B, the metadata group G corresponds to a data group (not shown) recorded in the data partition DP.

FIG. 7A shows a case where the end position of the data A is located on the BOT side with respect to the end position of the metadata group G. FIG. 7B shows a case where the end position of the data A is located on the EOT side with respect to the end position of the metadata group G. Here, an address value indicating the end position in the tape running direction of the data recorded in the data partition DP is defined as a first address value A1. Further, an address value indicating the end position in the tape running direction of the latest metadata recorded in the reference partition RP is defined as a second address value A2. The address value is assigned a numerical value that gradually increases from the BOT to the EOT of the magnetic tape 30, and uniquely specifies the position of the magnetic tape 30 in the tape running direction. Further, an address relative value R, which is a relative value between the first address value A1 and the second address value A2, is defined as in Equation (1).

R=A1−A2 (1)

In the case shown in FIG. 7A, in a case where the first address value A1 is, for example, 9900 and the second address value A2 is, for example, 10000, the address relative value R is −100. On the other hand, in the case shown in FIG. 7B, in a case where the first address value A1 is, for example, 11000 and the second address value A2 is, for example, 10000, the address relative value R is 1000.

The recording unit 14 of the information processing device 10 performs control to record metadata corresponding to data recorded in the data partition DP after the latest metadata is recorded, in the reference partition RP, in a case where the address relative value R is within a predetermined range.

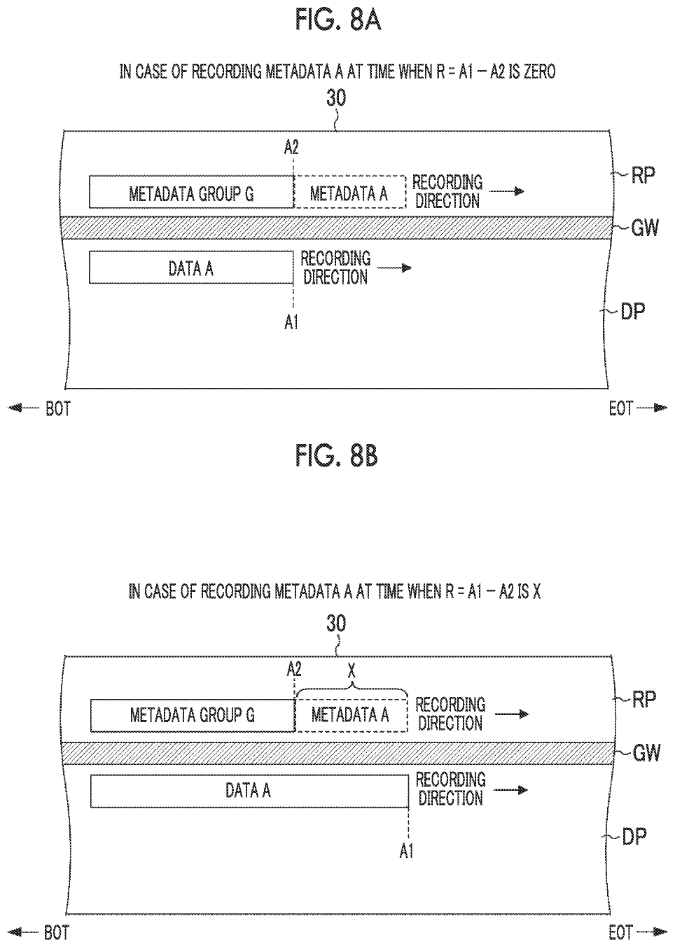

FIG. 8A illustrates a case where metadata A corresponding to data A is recorded in the reference partition RP at the time when the address relative value R is zero. In this case, the relative movement distance of the recording head in the tape running direction from the end position of the data A to the recording start position of the metadata A (that is, the end position of the metadata group G) is substantially zero in a case where the idle running of the recording head during movement is ignored.

Meanwhile, FIG. 8B illustrates a case where metadata A corresponding to data A is recorded in the reference partition RP at the time when the address relative value R is a value X corresponding to the size of the metadata A to be recorded. In other words, the metadata A is recorded in the reference partition RP at the time when the first address value A1 matches the address value of the assumed end position of the metadata A to be recorded. In this case, the relative movement distance of the recording head in the tape running direction from the end position of the data A to the recording start position of the metadata A (that is, the end position of the metadata group G) is a distance corresponding to the size of the metadata A. However, in a case where new data is recorded from the end position of the data A after the metadata A is recorded, the relative movement distance of the recording head in the tape running direction from the end position of the metadata A to the end position of the data A is substantially zero in a case where the idle running of the recording head during movement is ignored.

That is, in a case where the idle running of the recording head when the recording head moves between the partitions is ignored, as an example, the recording unit 14 performs control to record metadata corresponding to data recorded in the data partition DP, in the reference partition RP, in a case where the address relative value R is within a range shown in Equation (2), so that the relative movement distance of the recording head can be made substantially the shortest.

0≤R≤X (2)

Since X in Equation (2) is a value corresponding to the size of the metadata to be recorded, the recording unit 14 may change the range of the address relative value R in which the recording of metadata is started, according to the size of metadata to be recorded. Alternatively, the range of the address relative value R used as a trigger for recording metadata in the reference partition RP may be two or more. For example, the front and back range centered on an address relative value of zero may be set as a first range, and the front and back range centered on the address relative value R and not overlapping with the first range may be set as a second range.

In the above description, the case where the idle running of the recording head when the recording head moves between the partitions is ignored has been shown, but a case where the idle running is not ignored will be described below.

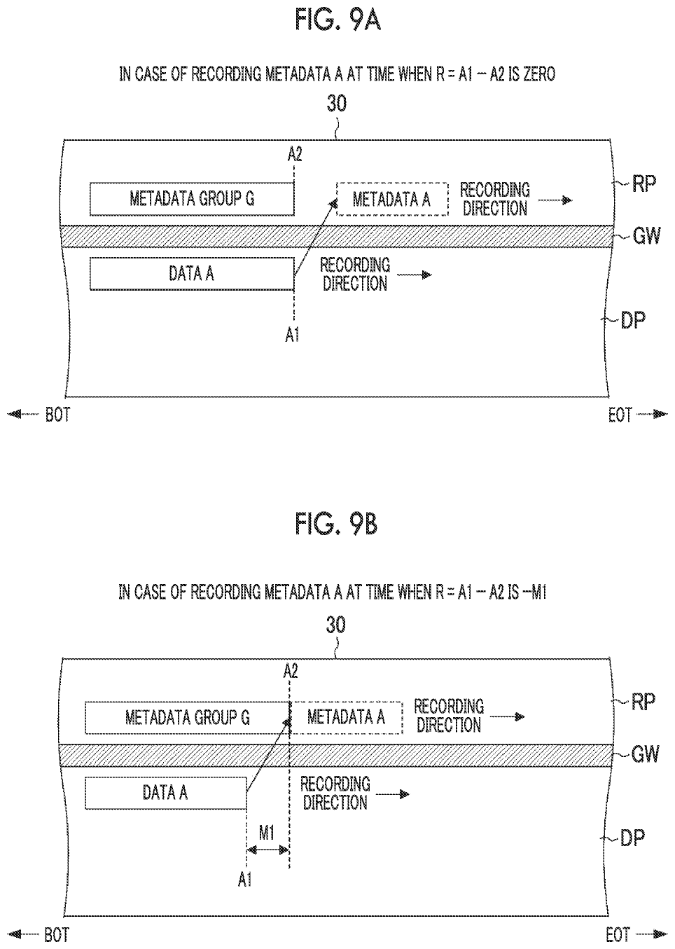

FIG. 9A illustrates a case where metadata A corresponding to data A is recorded in the reference partition RP at the time when the address relative value R is zero. The magnetic tape 30 is running while the recording head moves between the partitions from the end position of the data A to the recording start position of the metadata A. Therefore, the recording head runs idle in the recording direction while the recording head moves between the partitions. Accordingly, in a case where the metadata A is to be recorded in the reference partition RP at the time when the address relative value R is zero, a position that deviates from the end position of the recorded metadata group G by an idle running distance is the recording start position of the metadata A. In this case, an idle area is formed between the recorded metadata group G and the metadata A to be recorded. In order to eliminate this idle area, it is necessary to reverse the running direction of the magnetic tape 30 and to align the recording start position of the metadata A with the end position of the metadata group G.

In that respect, as shown in FIG. 9B, metadata A is recorded in the reference partition RP at the time when the end position of data A reaches a position preceding the end position of the recorded metadata group G by an address difference M1 corresponding to the idle running distance of the recording head, that is, at the time when R=−M1, so that it is possible to prevent the deviation of the recording start position of the metadata A caused by the idle running of the recording head.

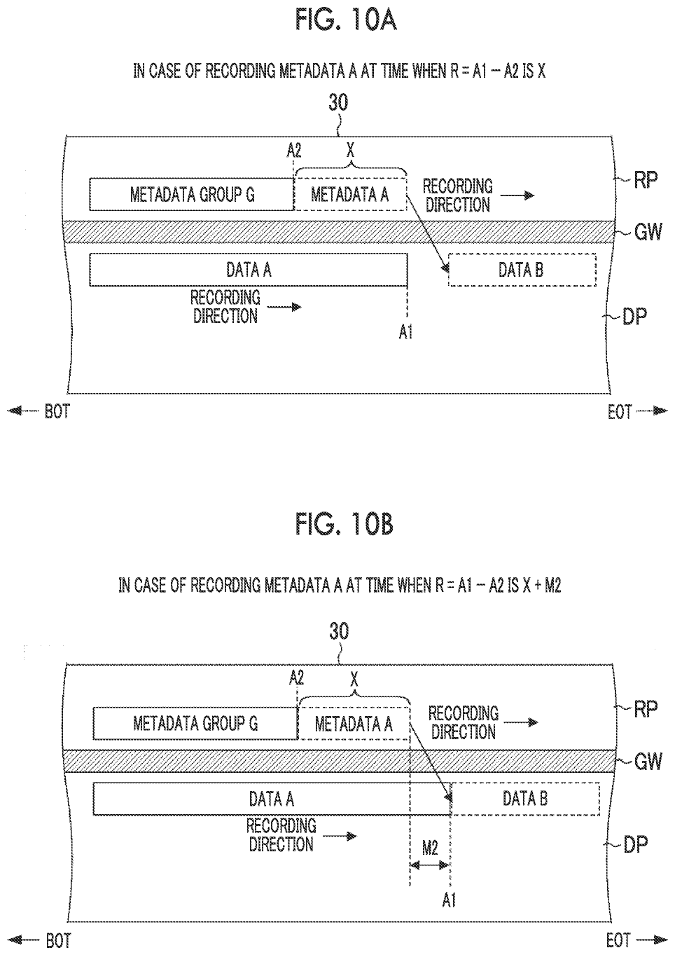

Meanwhile, FIG. 10A illustrates a case where data B is further recorded in the data partition DP after metadata A is recorded, in a case where the metadata A is recorded in the reference partition RP at the time when the address relative value R is a value X corresponding to the size of the metadata A to be recorded.

The magnetic tape 30 is running while the recording head moves between the partitions from the end position of the metadata A to the recording start position of the data B. Therefore, the recording head runs idle in the recording direction while the recording head moves between the partitions. Accordingly, in a case where the metadata A is to be recorded in the reference partition RP at the time when the address relative value R is the value X corresponding to the size of the metadata A to be recorded, a position that deviates from the end position of the metadata A by an idle running distance is the recording start position of the data B. In this case, an idle area is formed between the data A and the data B. In order to eliminate this idle area, it is necessary to reverse the running direction of the magnetic tape 30 and to align the recording start position of the data B with the end position of the data A.

In that respect, as shown in FIG. 10B, the metadata A is recorded in the reference partition RP at the time when the end position of the data A reaches a position advanced by an address difference M2 corresponding to the idle running distance from an assumed end position of the metadata A to be recorded, that is, at the time when R=X+M2, so that it is possible to prevent the deviation of the recording start position of the data B caused by the idle running of the recording head.

That is, in a case where the idle running of the recording head when the recording head moves between the partitions is not ignored, as an example, the recording unit 14 performs control to record metadata corresponding to data recorded in the data partition DP, in the reference partition RP, in a case where the address relative value R is within a range shown in Equation (3), so that the relative movement distance of the recording head can be made substantially the shortest.

−M1≤R≤X+M2 (3)

Since X in Equation (3) is a value corresponding to the size of the metadata to be recorded, the recording unit 14 may change the range of the address relative value R in which the recording of metadata is started, according to the size of metadata to be recorded. Further, since M1 and M2 in Equation (3) are values corresponding to the idle running distance of the recording head in the tape running direction when the recording head moves between the partitions and depend on the running speed of the magnetic tape 30, the recording unit 14 may change the range of the address relative value R in which the recording of metadata is started, according to the running speed of the magnetic tape 30. Alternatively, the range of the address relative value R used as a trigger for recording metadata in the reference partition RP may be two or more. For example, the front and back range centered on an address relative value of −M1 may be set as a first range, and the front and back range centered on an address relative value of X+M2 and not overlapping with the first range may be set as a second range.

In the above description, the case where the recording direction of data recorded in the data partition DP and the recording direction of metadata recorded in the reference partition RP are the same has been shown, but a case where the recording direction of the data and the recording direction of the metadata are different from each other will be described below.

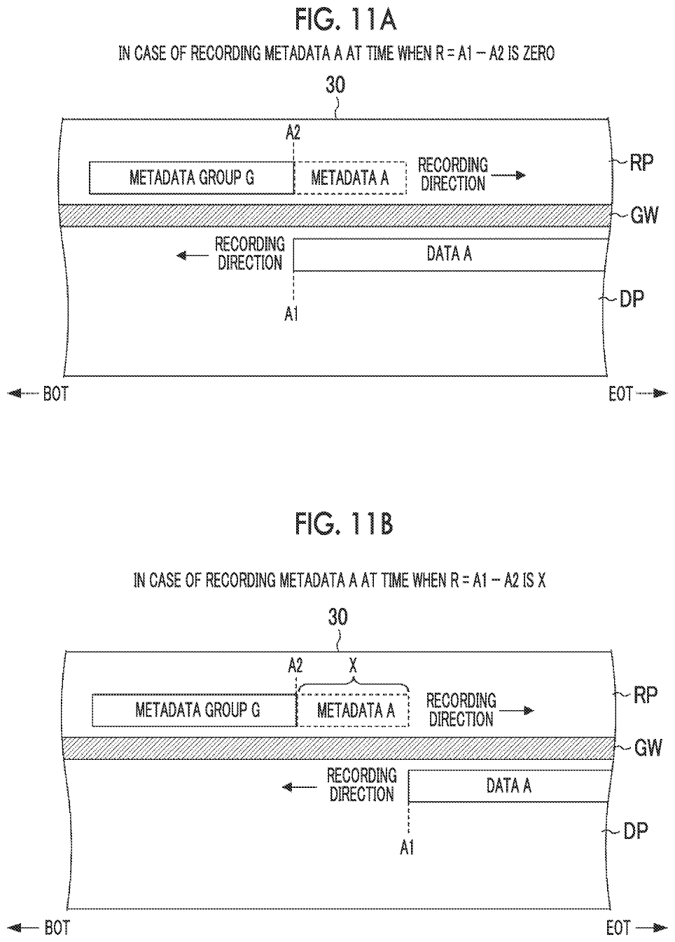

FIG. 11A illustrates a case where metadata A corresponding to data A is recorded in the reference partition RP at the time when the address relative value R is zero, in a case where the recording direction of data is a reverse direction from the EOT to the BOT and the recording direction of metadata is a forward direction from the BOT to the EOT. In this case, the relative movement distance of the recording head in the tape running direction from the end position of the data A to the recording start position of the metadata A (that is, the end position of the metadata group G) is substantially zero in a case where the idle running of the recording head during movement is ignored.

Meanwhile, FIG. 11B illustrates a case where metadata A is recorded in the reference partition RP at the time when the address relative value R is a value X corresponding to the size of the metadata A to be recorded, in a case where the recording direction of data is a reverse direction from the EOT to the BOT and the recording direction of metadata is a forward direction from the BOT to the EOT. In this case, the relative movement distance of the recording head in the tape running direction from the end position of the data A to the recording start position of the metadata A (that is, the end position of the metadata group G) is a distance corresponding to the size of the metadata A. However, in a case where new data is recorded from the end position of the data A after the metadata A is recorded, the relative movement distance of the recording head in the tape running direction from the end position of the metadata A to the end position of the data A is substantially zero in a case where the idle running of the recording head during movement is ignored.

That is, in a case where the idle running of the recording head when the recording head moves between the partitions is ignored even in a case where the recording direction of data and the recording direction of metadata are different from each other, as an example, the recording unit 14 performs control to record metadata corresponding to data recorded in the data partition DP, in the reference partition RP, in a case where the address relative value R is within a range shown in Equation (2), so that the relative movement distance of the recording head can be made substantially the shortest.

In the above description, the case where the idle running of the recording head when the recording head moves between the partitions is ignored in a case where the recording direction of data and the recording direction of metadata are opposite to each other has been described, but a case where the idle running is not ignored will be described below.

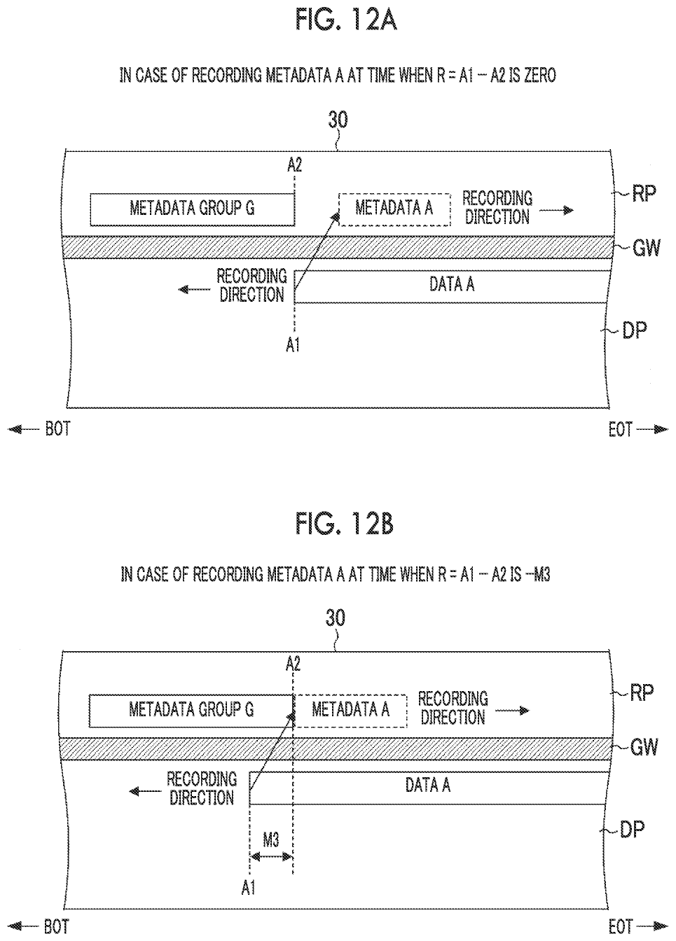

FIG. 12A illustrates a case where metadata A corresponding to data A is recorded in the reference partition RP at the time when the address relative value R is zero, in a case where the recording direction of data is a reverse direction from the EOT to the BOT and the recording direction of metadata is a forward direction from the BOT to the EOT. The magnetic tape 30 is running while the recording head moves between the partitions from the end position of the data A to the recording start position of the metadata A. Therefore, the recording head runs idle in the recording direction while the recording head moves between the partitions. Accordingly, it is considered that a position that deviates from the end position of the recorded metadata group G by an idle running distance is the recording start position of the metadata A, in a case where the metadata A is to be recorded in the reference partition RP at the time when the address relative value R is zero. In this case, an idle area is formed between the recorded metadata group G and the metadata A to be recorded. In order to eliminate this idle area, it is necessary to reverse the running direction of the magnetic tape 30 and to align the recording start position of the metadata A with the end position of the metadata group G.

In that respect, as shown in FIG. 12B, metadata A is recorded in the reference partition RP at the time when the end position of data A reaches a position advanced by an address difference M3 corresponding to the idle running distance of the recording head from the end position of the recorded metadata group G, that is, at the time when R=−M3, so that it is possible to prevent the deviation of the recording start position of the metadata A caused by the idle running of the recording head.

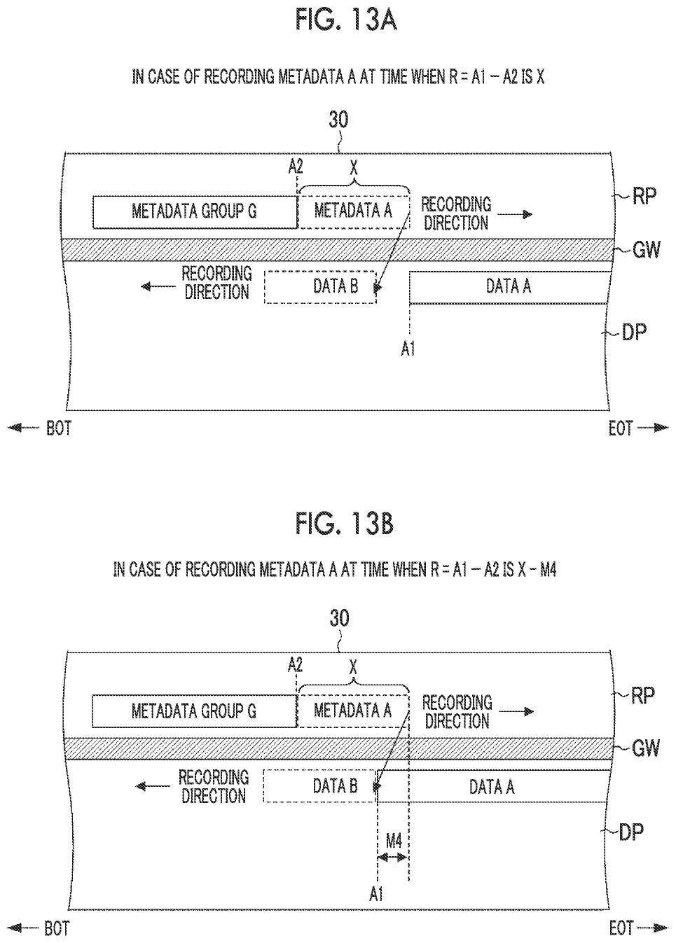

Meanwhile, FIG. 13A illustrates a case where data B is further recorded in the data partition DP after metadata A is recorded in a case where the metadata A is recorded in the reference partition RP at the time when the address relative value R is a value X corresponding to the size of the metadata A to be recorded, in a case where the recording direction of data is a reverse direction from the EOT to the BOT and the recording direction of metadata is a forward direction from the BOT to the EOT.

The magnetic tape 30 is running while the recording head moves between the partitions from the end position of the metadata A to the recording start position of the data B. Therefore, the recording head runs idle in the recording direction while the recording head moves between the partitions. Accordingly, it is considered that a position that deviates from the end position of the metadata A by an idle running distance is the recording start position of the data B, in a case where the metadata A is to be recorded in the reference partition RP at the time when the address relative value R is the value X corresponding to the size of the metadata A to be recorded. In this case, an idle area is formed between the data A and the data B. In order to eliminate this idle area, it is necessary to reverse the running direction of the magnetic tape 30 and to align the recording start position of the data B with the end position of the data A.

In that respect, as shown in FIG. 13B, the metadata A is recorded in the reference partition RP at the time when the end position of the data A reaches a position advanced by an address difference M4 corresponding to the idle running distance from an assumed end position of the metadata A to be recorded, that is, at the time when R=X−M4, so that it is possible to shorten the relative movement distance of the recording head and to prevent the deviation of the recording start position of the data B caused by the idle running of the recording head.

That is, in a case where the idle running of the recording head when the recording head moves between the partitions is not ignored in a case where the recording direction of data is a reverse direction from the EOT to the BOT and the recording direction of metadata is a forward direction from the BOT to the EOT, as an example, the recording unit 14 performs control to record metadata corresponding to data recorded in the data partition DP, in the reference partition RP, in a case where the address relative value R is within a range shown in Equation (4), so that the relative movement distance of the recording head can be made substantially the shortest.

−M3≤R≤X−M4 (4)

Since X in Equation (4) is a value corresponding to the size of the metadata to be recorded, the recording unit 14 may change the range of the address relative value R in which the recording of metadata is started, according to the size of metadata to be recorded. Further, since M3 and M4 in Equation (4) are values corresponding to the idle running distance of the recording head in the tape running direction when the recording head moves between the partitions and depend on the running speed of the magnetic tape 30, the recording unit 14 may change the range of the address relative value R in which the recording of metadata is started, according to the running speed of the magnetic tape 30. Alternatively, the range of the address relative value R used as a trigger for recording metadata in the reference partition RP may be two or more. For example, the front and back range centered on an address relative value of −M3 may be set as a first range, and the front and back range centered on an address relative value of X−M4 and not overlapping with the first range may be set as a second range.

Further, since it is assumed that the idle running distance of the recording head in the tape running direction when the recording head moves between the partitions varies according to the recording directions of data and metadata, the recording unit 14 may change the allowable range of the address relative value R in which the recording of metadata is started, according to the recording directions of data and metadata.

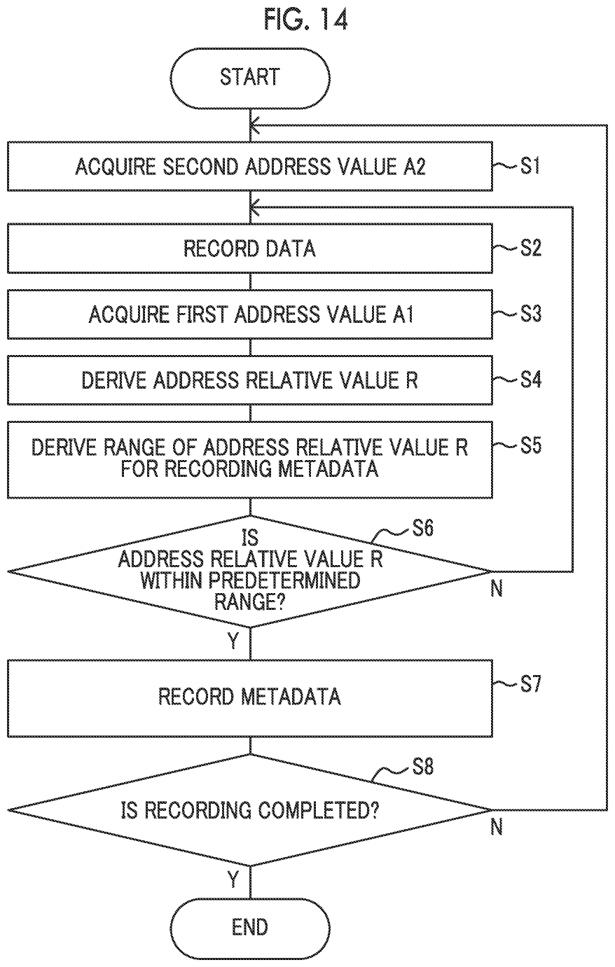

The action of the information processing device 10 will be described below. FIG. 14 is a flowchart showing an example of a flow of recording processing that is implemented by the CPU 101 executing the information processing program 110. The information processing program 110 is executed, for example, in a case where an instruction to execute recording processing is input by the user via the input unit 105. The data and metadata to be recorded on the magnetic tape 30 are received by the reception unit 11 and stored in the data cache 12 and the metadata DB 13.

In step S1, the recording unit 14 acquires the second address value A2 indicating the end position of the latest metadata recorded in the reference partition RP of the magnetic tape 30, from the control unit 21 of the tape drive 20. In a case where metadata has not yet been recorded on the magnetic tape 30, the recording unit 14 may acquire the recording start position of metadata first recorded in the reference partition RP, as the second address value A2.

In step S2, the recording unit 14 controls the control unit 21 of the tape drive 20 to record data recorded in the data cache 12, in the data partition DP.

In step S3, the recording unit 14 acquires the first address value A1 indicating the end position of data recorded in the data partition DP, from the control unit 21 of the tape drive 20 in response to the control of step S2.

In step S4, the recording unit 14 derives the address relative value R (=A1−A2) which is the relative value between the second address value A2 acquired in step S1 and the first address value A1 acquired in step S3.

In step S5, the recording unit 14 derives the range of the address relative value R used to determine whether or not to record metadata corresponding to the data recorded in the data partition DP (determination performed in step S6). As described above, the recording unit 14 derives the range of the address relative value R used for the above determination, on the basis of, for example, at least one of the size of metadata to be recorded, the running speed of the magnetic tape 30, or the recording directions of data and metadata. The recording unit 14 may set the range of the address relative value R used for the above determination to a predetermined range.

In step S6, the recording unit 14 determines whether or not the address relative value R derived in step S4 is within the range derived in step S5. In a case where the address relative value R is not within the above range, the process returns to step S2. That is, in this case, the processing of recording data in the data partition DP is continuously performed. On the other hand, in a case where the address relative value R is within the above range, the process proceeds to step S7.

In step S7, the recording unit 14 controls the control unit 21 of the tape drive 20 to record metadata corresponding to the data recorded in the data partition DP, in the reference partition RP.

In step S8, the recording unit 14 determines whether or not all the data and metadata to be recorded have been recorded on the magnetic tape 30. This routine ends in a case where the recording of all the data and metadata to be recorded, on the magnetic tape 30, is completed. The processing from step S1 to step S7 is repeated until the recording of all the data and the metadata to be recorded, on the magnetic tape 30, is completed.

As described above, with the information processing device 10 according to the embodiment of the disclosed technique, in a case where the address relative value R between the first address value A1 indicating the end position in the tape running direction of the recorded data which is data recorded in the data partition DP and the second address value A2 indicating the end position in the tape running direction of the latest metadata recorded in the reference partition RP is within a predetermined range, control to record metadata corresponding to the recorded data in the reference partition RP is performed. In this way, it is possible to prevent the recording position of data and the recording position of metadata from significantly deviating from each other by determining the metadata recording timing using the address relative value R, so that it is possible to shorten the movement distance of the recording head relative to the magnetic tape and to shorten the time required for recording data and metadata.

For example, in a case where the total length of the magnetic tape is 1 km, the recording position of data and the recording position of metadata may deviate from each other by a maximum of about 1 km. In this case, assuming that the running speed of the magnetic tape is 10 m/sec, it takes about 100 seconds to start recording the metadata after recording the data. With the information processing device 10 according to the embodiment of the disclosed technique, the time from the recording of the data to the start of the recording of the metadata can be made to about 5 seconds, which is required for the back hitch, and it is possible to realize a time reduction of up to 95%.

In the above-described embodiment, the case where the metadata recording timing is determined without considering the number or size of data recorded in the data partition DP has been exemplified, but the metadata recording timing may be determined in consideration of the number or size of data recorded in the data partition DP after the latest metadata is recorded. That is, the information processing device 10 may perform control to record metadata corresponding to the recorded data, in the reference partition RP, in a case where the address relative value R is within a predetermined range and the number or size of the recorded data recorded after the latest metadata is recorded is a predetermined value or more.

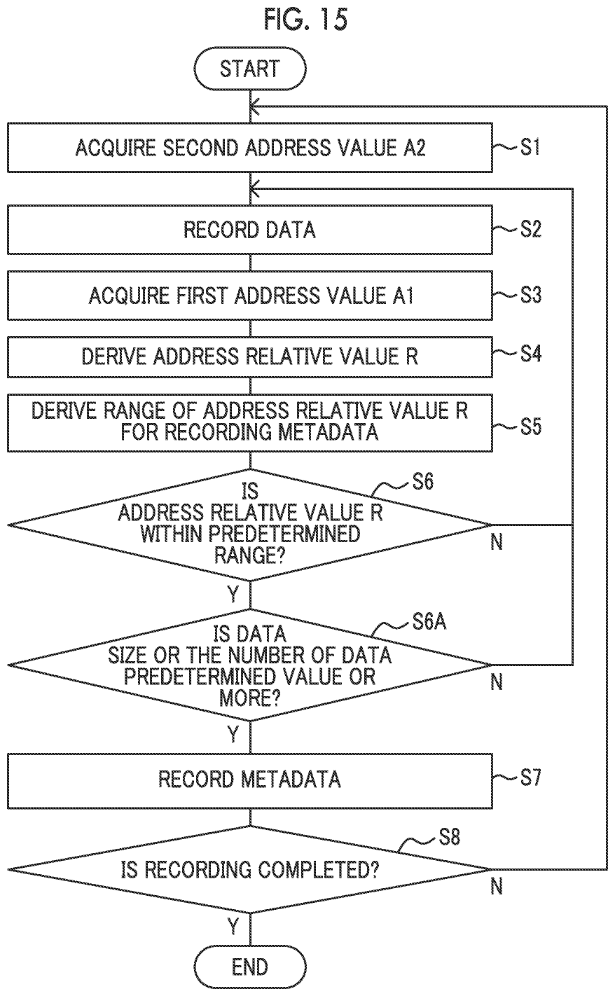

FIG. 15 is a flowchart showing an example of a flow of recording processing in a case where the metadata recording timing is determined in consideration of the number or size of data recorded in the data partition DP after the latest metadata is recorded. The flowchart shown in FIG. 15 is different from the flowchart shown in FIG. 14 in that step S6A is added after step S6.

In step S6A, the recording unit 14 determines whether or not the number or size of data recorded in the data partition DP after the latest metadata recorded in the reference partition RP is recorded is a predetermined value or more. The process proceeds to step S7 in a case where the recording unit 14 determines that the number or size of data is the predetermined value or more, and the process returns to step S2 in a case where the recording unit 14 determines that the number or size of data is less than the predetermined value.

In this way, the metadata recording timing is determined in consideration of not only the address relative value R but also the number or size of data recorded in the data partition DP after the latest metadata is recorded, so that it is possible to reduce the number of times of recording processing of metadata.

Alternatively, the metadata recording timing may be determined in consideration of the passed time from a point in time when the latest metadata is recorded. That is, the information processing device 10 may perform control to record metadata corresponding to the recorded data, in the reference partition RP, in a case where the address relative value R is within a predetermined range and a predetermined time is passed from the point in time when the latest metadata is recorded.

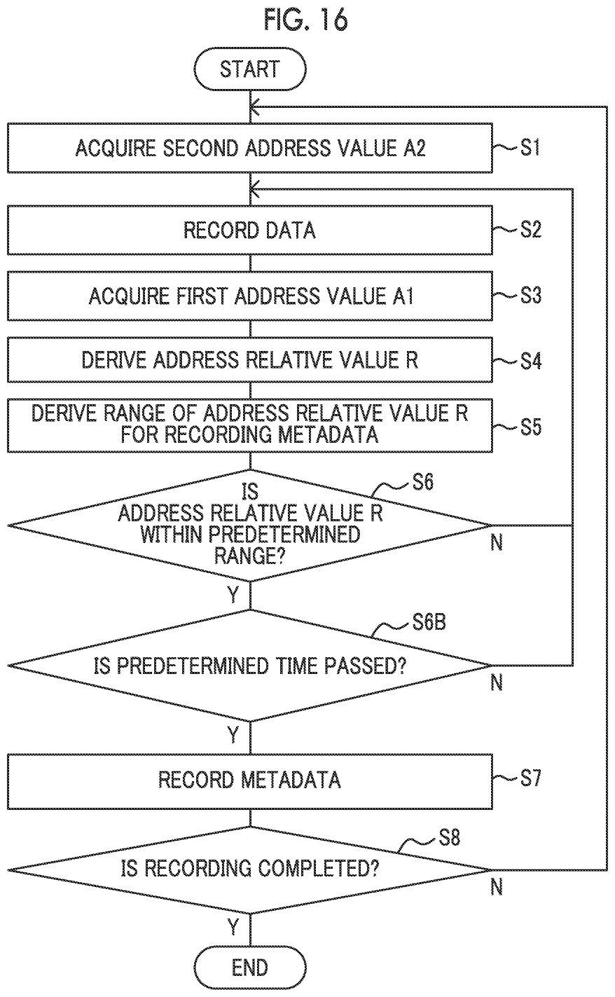

FIG. 16 is a flowchart showing an example of a flow of recording processing in a case where the metadata recording timing is determined in consideration of the passed time from the point in time when the latest metadata is recorded. The flowchart shown in FIG. 16 is different from the flowchart shown in FIG. 14 in that step S6B is added after step S6.

In step S6B, the recording unit 14 determines whether or not a predetermined time is passed from the point in time when the latest metadata recorded in the reference partition RP is recorded. The process proceeds to step S7 in a case where the recording unit 14 determines that the predetermined time is passed, and the process returns to step S2 in a case where the recording unit 14 determines that the predetermined time is not passed.

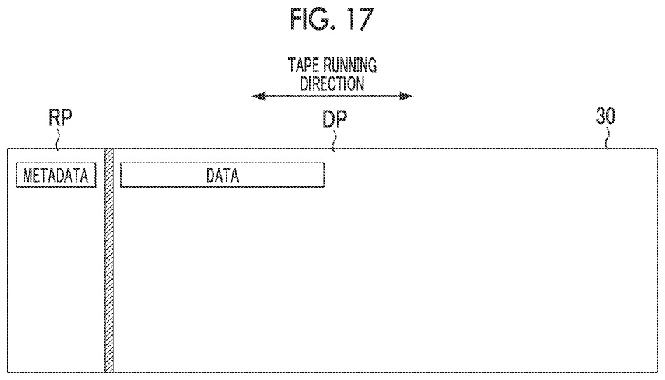

Further, in the above-described embodiment, the case where data and metadata are recorded in the data partition DP and the reference partition RP separated from each other in the width direction intersecting the tape running direction, respectively, has been exemplified, but the disclosed technique can be applied to a case where data and metadata are recorded in the data partition DP and the reference partition RP separated from each other in the tape running direction, respectively, as shown in FIG. 17.

Further, in the above-described embodiment, the case where the CPU 101 provided in the information processing device 10 performs the above-described recording processing has been exemplified, but a processor provided in the control unit 21 of the tape drive 20 may perform the above-described recording processing.

Further, in the above-described embodiment, the case where data is recorded in the data partition DP has been exemplified, but an object including data to be stored by the user, such as document data and image data, and metadata corresponding to the data may be recorded in the data partition DP. In this case, the metadata is recorded in the reference partition RP and is also included in the object recorded in the data partition DP. A storage system that handles this object is referred to as an object storage system.

Further, in the above-described embodiment, for example, the following various processors can be used as the hardware structure of a processing unit that executes various kinds of processing, such as the reception unit 11 and the recording unit 14. The above-described various processors include, for example, a programmable logic device (PLD) which is a processor having a changeable circuit configuration after manufacture, such as an FPGA, and a dedicated electrical circuit which is a processor having a dedicated circuit configuration designed to perform specific processing, such as an application specific integrated circuit (ASIC), in addition to the CPU which is a general-purpose processor that executes software (programs) to function as various processing units, as described above.

One processing unit may be composed of one of these various processors or a combination of two or more processors of the same type or different types (for example, a combination of a plurality of FPGAs or a combination of a CPU and an FPGA). Alternatively, a plurality of processing units may be composed of one processor.

A first example in which a plurality of processing units are composed of one processor is an aspect in which one or more CPUs and software are combined to constitute one processor and the processor functions as the plurality of processing units, as typified by a computer, such as a client and a server. A second example is an aspect in which a processor that realizes all the functions of a system including the plurality of processing units with one integrated circuit (IC) chip is used, as typified by a system on chip (SoC). As described above, various processing units are formed of one or more of the above-described various processors as the hardware structure.

Further, as the hardware structure of these various processors, more specifically, an electric circuit (circuitry) in which circuit elements, such as semiconductor elements, are combined can be used.

Further, in the above-described embodiment, the aspect in which the information processing program 110 is stored (installed) in the storage unit 103 in advance has been described, but the disclosed technique is not limited thereto. The information processing program 110 may be provided in a form of being recorded on a recording medium, such as a compact disc read only memory (CD-ROM), a digital versatile disc read only memory (DVD-ROM), and a Universal Serial Bus (USB) memory. Alternatively, the information processing program 110 may be downloaded from an external device via a network.

The disclosure of JP2020-039322 filed on Mar. 6, 2020 is incorporated herein by reference in its entirety. In addition, all documents, patent applications, and technical standards described in the present specification are incorporated in the present specification by reference, to the same extent as in the case where each of the documents, patent applications, and technical standards is specifically and individually described.

What is claimed is:

1. An information processing device comprising:
at least one processor,
wherein the processor
performs, in a case where an address relative value between a first address value indicating an end position in a tape running direction of recorded data which is data recorded in a first partition of a magnetic tape having the first partition in which data is recorded and a second partition in which metadata corresponding to the data is recorded and a second address value indicating an end position in the tape running direction of latest metadata recorded in the second partition is within a predetermined range, control to record metadata corresponding to recorded data recorded after the latest metadata is recorded, in the second partition.

2. The information processing device according to claim 1,
wherein the processor performs control to record the metadata corresponding to the recorded data recorded after the latest metadata is recorded, in the second partition, in a case where the address relative value is within the predetermined range and the number or a size of the recorded data recorded after the latest metadata is recorded is a predetermined value or more.

3. The information processing device according to claim 1,
wherein the processor performs control to record the metadata corresponding to the recorded data recorded after the latest metadata is recorded, in the second partition, in a case where the address relative value is within the predetermined range and a predetermined time is passed from a point in time when the latest metadata is recorded.

4. The information processing device according to claim 2,
wherein the processor performs control to record the metadata corresponding to the recorded data recorded after the latest metadata is recorded, in the second partition, in a case where the address relative value is within the predetermined range and a predetermined time is passed from a point in time when the latest metadata is recorded.

5. The information processing device according to claim 1,
wherein the processor changes the predetermined range according to at least one of a size of the metadata corresponding to the recorded data recorded after the latest metadata is recorded, a running speed of the magnetic tape, or a recording direction in a case where the data and the metadata are recorded on the magnetic tape.

6. The information processing device according to claim 4,
wherein the processor changes the predetermined range according to at least one of a size of the metadata corresponding to the recorded data recorded after the latest metadata is recorded, a running speed of the magnetic tape, or a recording direction in a case where the data and the metadata are recorded on the magnetic tape.

7. The information processing device according to claim 1,
wherein a plurality of ranges of the address relative value are set as the predetermined range.

8. The information processing device according to claim 6,
wherein a plurality of ranges of the address relative value are set as the predetermined range.

9. The information processing device according to claim 1,
wherein the first partition and the second partition are storage areas separated from each other in a width direction intersecting the tape running direction.

10. The information processing device according to claim 8,
wherein the first partition and the second partition are storage areas separated from each other in a width direction intersecting the tape running direction.

11. The information processing device according to claim 1,
wherein the first partition and the second partition are storage areas separated from each other in the tape running direction.

12. The information processing device according to claim 6,
wherein the first partition and the second partition are storage areas separated from each other in the tape running direction.

13. An information processing method executed by a processor provided in an information processing device, the method comprising:
performing, in a case where an address relative value between a first address value indicating an end position in a tape running direction of recorded data which is data recorded in a first partition of a magnetic tape having the first partition in which data is recorded and a second partition in which metadata corresponding to the data is recorded and a second address value indicating an end position in the tape running direction of latest metadata recorded in the second partition is within a predetermined range, control to record metadata corresponding to recorded data recorded after the latest metadata is recorded, in the second partition.

14. A non-transitory computer-readable storage medium storing an information processing program for causing a processor provided in an information processing device to execute a process comprising:
performing, in a case where an address relative value between a first address value indicating an end position in a tape running direction of recorded data which is data recorded in a first partition of a magnetic tape having the first partition in which data is recorded and a second partition in which metadata corresponding to the data is recorded and a second address value indicating an end position in the tape running direction of latest metadata recorded in the second partition is within a predetermined range, control to record metadata corresponding to recorded data recorded after the latest metadata is recorded, in the second partition.
